(19) United States
(12) Patent Application Publication
(10) Pub. No.: US 2011/0162124 A1
(43) Pub. Date: Jul. 7, 2011

(54) SYSTEMS AND METHODS OF COLLECTING AND/OR DISPLAYING COLLECTIBLE ARTISTIC RENDERINGS

(76) Inventors: Joseph A. Cosentino, West Islip, NY (US); Angela M. Cosentino, West Islip, NY (US); Brien M. Wassner, New York, NY (US); Mary A. Wassner, New York, NY (US)

(21) Appl. No.: 12/985,030

(22) Filed: Jan. 5, 2011

Related U.S. Application Data
(60) Provisional application No. 61/292,344, filed on Jan. 5, 2010.

(51) Int. Cl. A41D 1/02; A41D 27/08; A41B 1/00; A41D 1/14; A42B 1/00; A41D 1/06; A45F 3/04; B42D 3/00; A63H 3/02; B42D 1/08; A41D 1/18

(52) U.S. Cl. 2/93; 2/244; 2/69; 2/211; 2/171; 2/227; 224/259; 281/29; 446/369; 281/38

(57) ABSTRACT

Collectible artistic renderings are integrated with an article of clothing or other clothing articles wherein the clothing article serves as a display for the collectible artistic renderings and the collectible artistic renderings serve to enhance and alter the look and design of the clothing article. The clothing articles themselves can include an image or pictorial representation serving as a backdrop. The collectible artistic renderings include a fastener for affixing such collectible artistic renderings to said clothing articles. The collectible artistic renderings can be collected, traded, and stored in a storage medium when not in use on a clothing article.

### CROSS-REFERENCE TO RELATED APPLICATIONS

This application claims priority to U.S. Provisional Patent Application No. 61/292,344, filed Jan. 5, 2010, the content of which is incorporated herein by reference in its entirety.

### FIELD OF THE INVENTION

The present invention relates to systems and methods of collecting and/or displaying collectible artistic renderings that can couple to articles of clothing or other articles.

### SUMMARY OF THE INVENTION

In exemplary embodiments, systems and/or methods for collecting and/or displaying collectible artistic renderings capable of coupling to article(s) of clothing can comprise: collectible artistic rendering(s) that can have a viewable side and/or a fastener side, wherein the fastener side can include fastener(s) and/or wherein the collectible artistic rendering can couple to article(s) of clothing. Further, the systems and/or methods, can include clothing that can have an inwardly facing side and/or an outwardly facing side, wherein fastener(s) can attach to the outwardly facing side of the clothing and/or wherein the fastener(s) of the collectible artistic rendering(s) couple to the fastener(s) of the clothing by cooperatively interacting. Further still, the systems and/or methods, can include a storage medium that can be for storing a plurality of the collectible artistic renderings; and/or wherein users can collect the collectible artistic renderings that can couple to the clothing generating articles with congruous, incongruous, random, and/or humorous renderings.

In exemplary embodiments, the clothing can further comprise a pictorial representation that can serve as a backdrop scene and that can include fasteners wherein the collectible artistic renderings are coupled. Also, users can choose the manner of completing the backdrop scene and/or display desired by coupling various collectible artistic renderings.

In exemplary embodiments, the pictorial representations can be applied by methods such as, for example, screening, lithograph, printing, and/or stenciling. Further, the pictorial representations can comprise a solid color, a plurality of colors, contain a geometric design, contain a non-geometric design, and/or can contain any design. Further still, the collectible artistic renderings, once attached, can be the focal point of the clothing such that the user can create related scenes, create more random displays, and/or creates incongruous displays of collectible artistic renderings.

In exemplary embodiments, the fastener of the clothing can be located exclusively in the backdrop scene and/or coupling the fastener of the collectible artistic rendering(s) to the fastener of the clothing, located exclusively in the backdrop scene, can complete the scene by being exclusively in the backdrop scene.

In exemplary embodiments, the fastener of the clothing can be located at predefined locations on the clothing, for example, such that users can only couple collectible artistic renderings at specific locations on the clothing.

In exemplary embodiments, the clothing can be a t-Shirt, a shirt, a sweatshirt, a sweater, a blouse, a skirt, a jacket, a backpack, a hat, a book cover, a stuffed animal, a lunch boxes and/or a pants.

In exemplary embodiments, the collectible artistic renderings can comprise embroidered fabric.

In exemplary embodiments, the fastener of the collectible artistic rendering, the fastener of the clothing, and/or the collectible artistic rendering can be selectively constructed for apparel, children's apparel, and/or children. Further, the fastener of the collectible artistic rendering, the fastener of the clothing, and/or the collectible artistic rendering can be selectively constructed for being flexible, washable, non-shrinking, and/or soft to the touch. Also, the criteria for selective construction can be to reduce the risk of injury to children.

In exemplary embodiments, the fastener of the collectible artistic rendering, the fastener of the clothing, and/or the collectible artistic rendering can be selectively constructed to substantially reduce the risk of injury to children by, for example, increasing the size of the collectible artistic rendering to reduce the risk of choking; modifying the shape of the collectible artistic rendering to reduce the risk of choking; producing the fastener of the collectible artistic rendering, the fastener of the clothing, and/or the collectible artistic rendering from non-toxic materials.

In exemplary embodiments, the storage medium can be a board, a banner, and/or a book. Further, the storage medium can be a book that can comprise a plurality of pages that can include a plurality of pockets and/or couplings for receiving the collectible artistic renderings, the storage medium can be a board that can include a plurality of pockets and/or couplings for receiving the collectible artistic renderings, and/or the storage medium can be a banner that can include a plurality of pockets and/or couplings for receiving the collectible artistic renderings.

In exemplary embodiments, the storage medium can be constructed of a flexible material with substantially rounded edges to substantially reduce the risk of injury to children. Also, the storage medium can be sized to fit in a standard child's pocket. Further, the storage medium can be designed to store a plurality of collectible artistic renderings to, for example, increase creativity by enabling children to trade the collectible artistic renderings and/or place various collectible artistic renderings on various articles of clothing.

### BRIEF DESCRIPTION OF THE DRAWINGS

The features and advantages of the present invention will be more fully understood with reference to the following detailed description of exemplary embodiments of the present invention when taken in conjunction with the accompanying figures, wherein:

FIGS. 1-2 illustrate an article of clothing including attached collectible artistic renderings, according to exemplary embodiments of the present invention;

FIG. 3 illustrates an article of clothing including collectible artistic renderings attached to a backdrop, according to exemplary embodiments of the present invention;

FIGS. 4-5 illustrate storage mediums for storing collectible artistic renderings, according to exemplary embodiments of the present invention;

FIGS. 6-11 illustrate various examples of articles of clothing including collectible artistic renderings attached to a backdrop, according to exemplary embodiments of the present invention;

FIGS. 12-14 illustrate exemplary collectible artistic renderings, according to exemplary embodiments of the present invention;

FIGS. 15-16 illustrate various examples of articles of clothing including a collectible artistic rendering attached, according to exemplary embodiments of the present invention; and

FIGS. 17-18 illustrate exemplary implementation of various games and/or other benefits from using collectible artistic renderings, according to exemplary embodiments of the present invention.

### DETAILED DESCRIPTION OF THE EXEMPLARY EMBODIMENTS

The present invention generally relates to systems and methods displaying collectible artistic renderings on articles of clothing or other articles thereby enhancing and/or altering the look and design of the articles and/or for collecting the collectible displayable collectible artistic renderings in a storage medium.

It will be understood that articles of clothing and/or other articles can include any article of clothing, such as, but not limited to, t-shirts, shirts, sweatshirts, sweaters, blouses, skirts, jackets, pants, hats, any combination thereof, and/or any other wearable garment as well as any other article, such as, but not limited to book covers, stuffed animals, backpacks, lunch boxes, any combination thereof, and/or any other reasonable article. For ease, the article of clothing and/or other article is, at times, illustratively depicted and/or described as a shirt. This is merely for ease and is in no way meant to be a limitation.

Further, it will be understood that the storage medium can be any medium capable of storing the collectible artistic renderings such as, but not limited to, a board, a banner, a book, any combination thereof, and/or any reasonable medium capable of storing the collectible artistic renderings. For ease, the storing medium is, at times, illustratively depicted and/or described as a book or banner. This is merely for ease and is in no way meant to be a limitation.

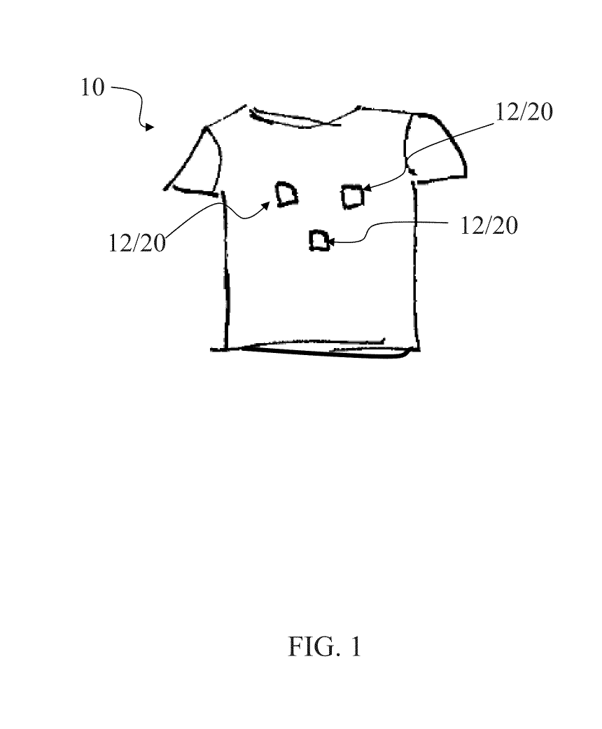

Referring to FIGS. 1-3, in exemplary embodiments, the systems and methods of displaying collectible artistic renderings can include, but is not limited to, a shirt 10 that can be include a solid color or colors or contain a geometric design or designs such that a collectible artistic renderings 20 can be coupled to shirt 10. As discussed herein, collectible artistic renderings 20 can include fasteners 22 (not shown) and shirt 10 can include fasteners 12 such that fasteners 22 (not shown) from collectible artistic renderings 20 can couple with fasteners 12 from shirt 10. Further, as discussed herein, collectible artistic renderings 20 can include fasteners 22 (not shown) and/or can also include an attaching region 24 (not shown) and shirt 10 can include fasteners 12 and/or can also include an attaching region 24 (not shown).

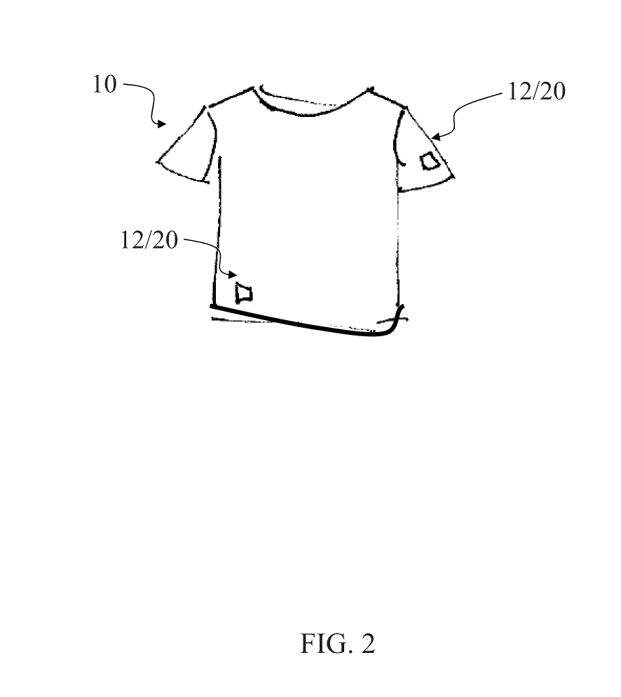

In exemplary embodiments, referring to FIGS. 1-2, shirt 10 can be of a solid color or colors or contain a geometric design or designs such that collectible artistic renderings 20 becomes the focal point of the article.

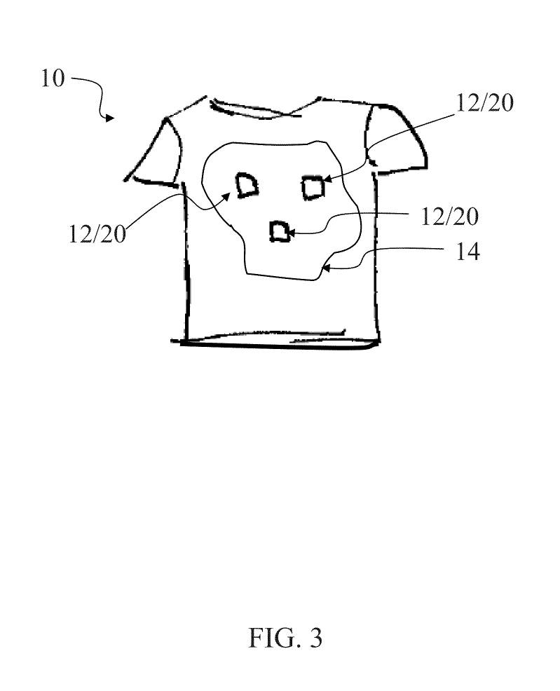

In exemplary embodiments, referring to FIG. 3, shirt 10 can contain an image or pictorial representation 14 serving as a backdrop such that collectible artistic renderings 20, once attached, can complete the scene. That is, in exemplary embodiments, the positioning of fastener 12 and/or artistic rendering 20 on shirt 10 containing an image or pictorial representation 14 serving as a backdrop can complete the scene by being located exclusively inside the image or pictorial representation 14 serving as a backdrop. For example, coupling fastener 22 of collectible artistic rendering 20 to fastener 12 of shirt 10, located exclusively in the backdrop scene, can complete the scene by being located exclusively in the backdrop scene.

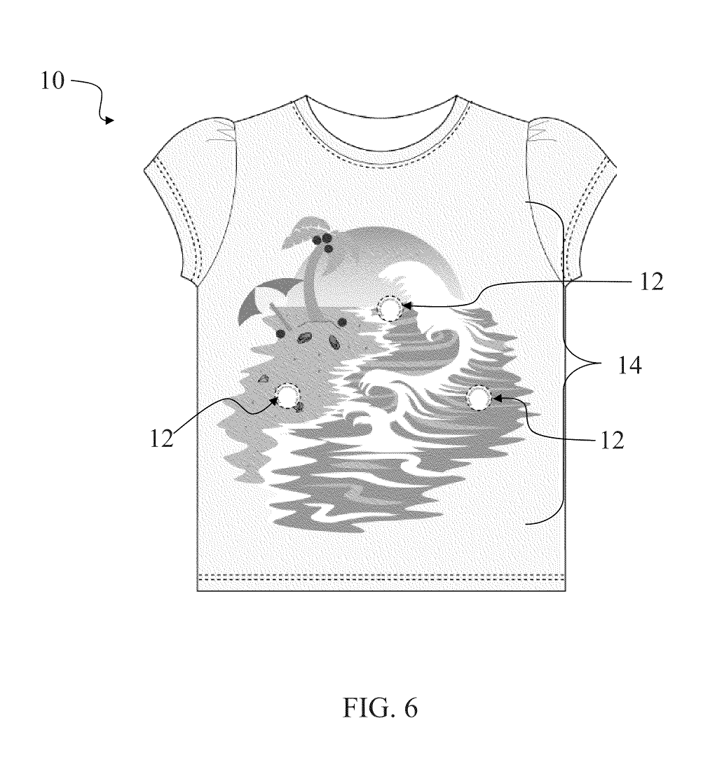

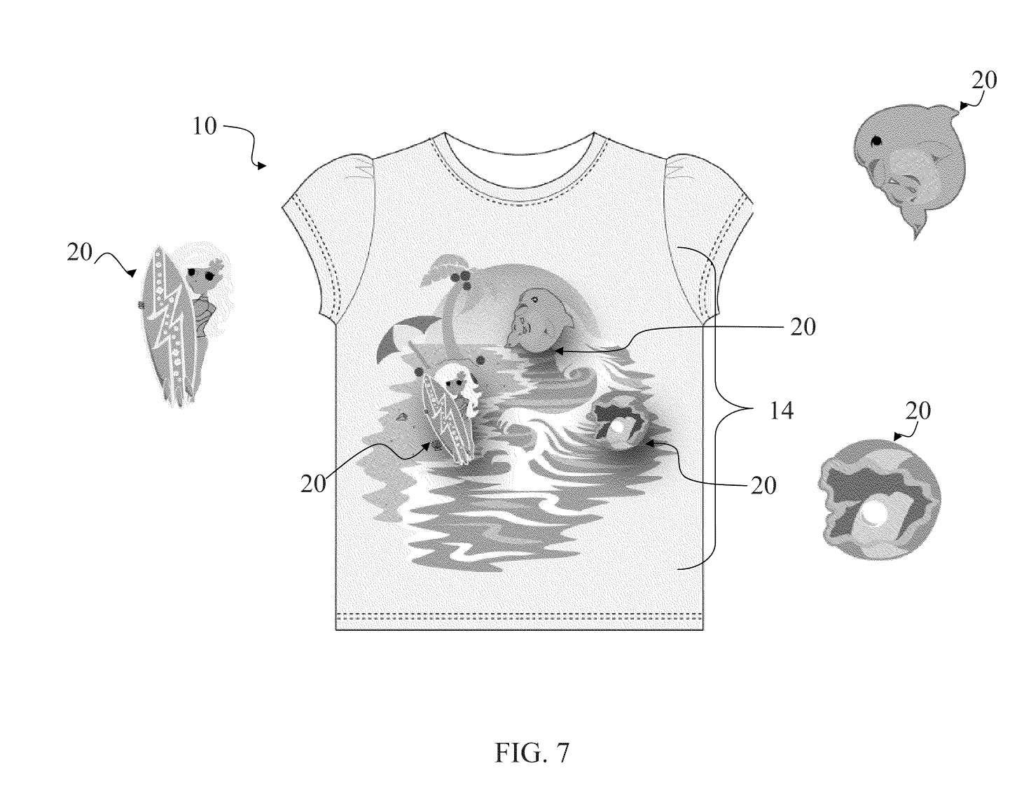

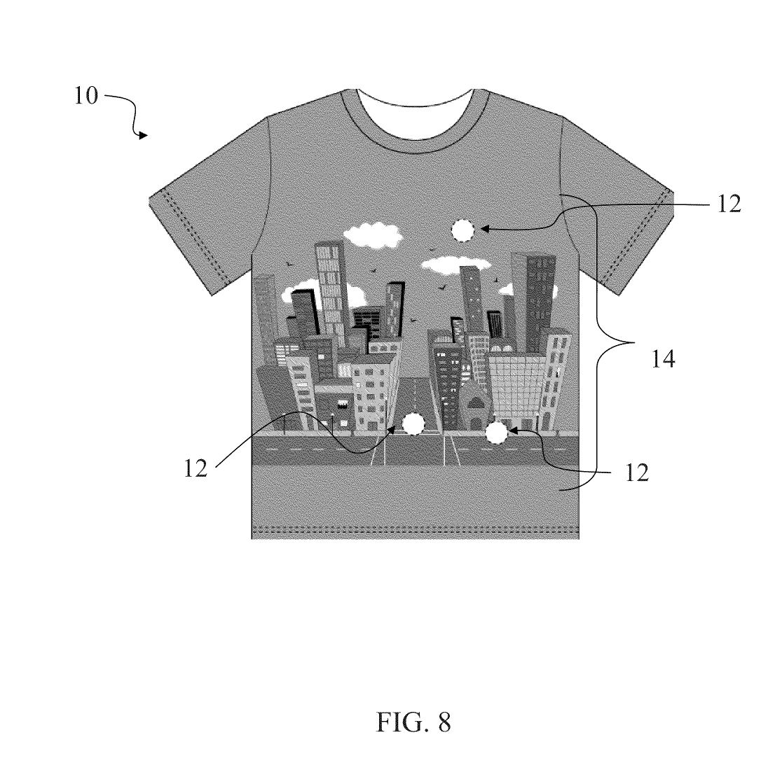

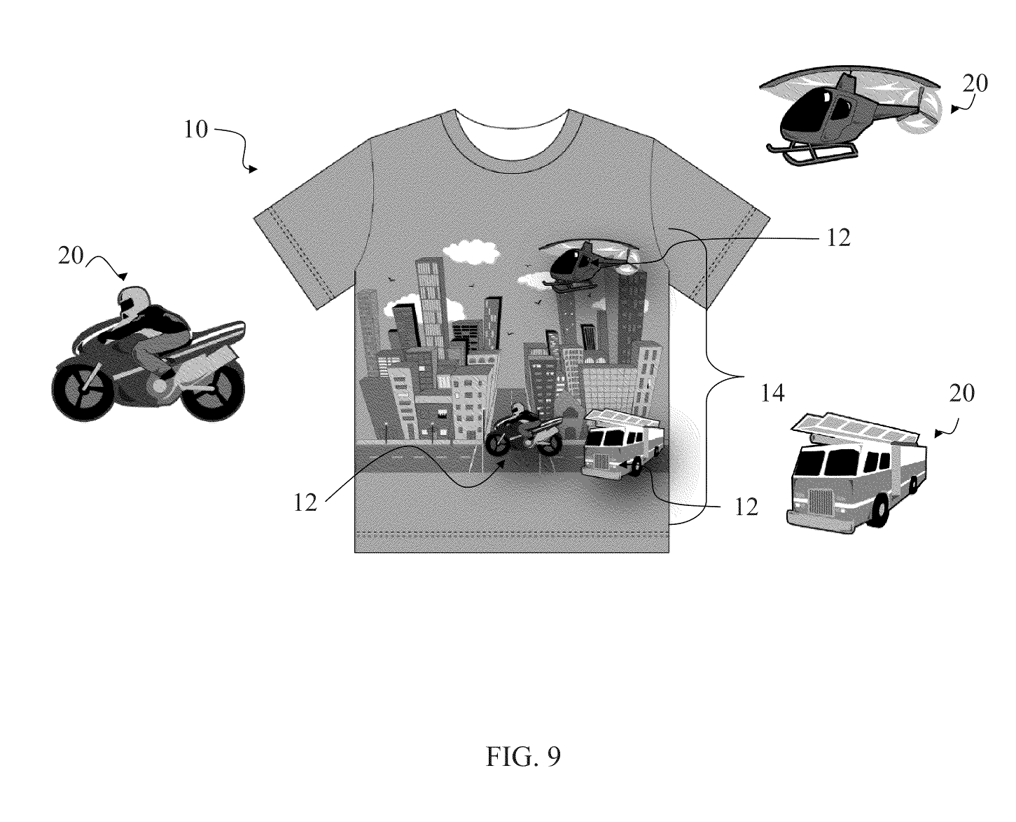

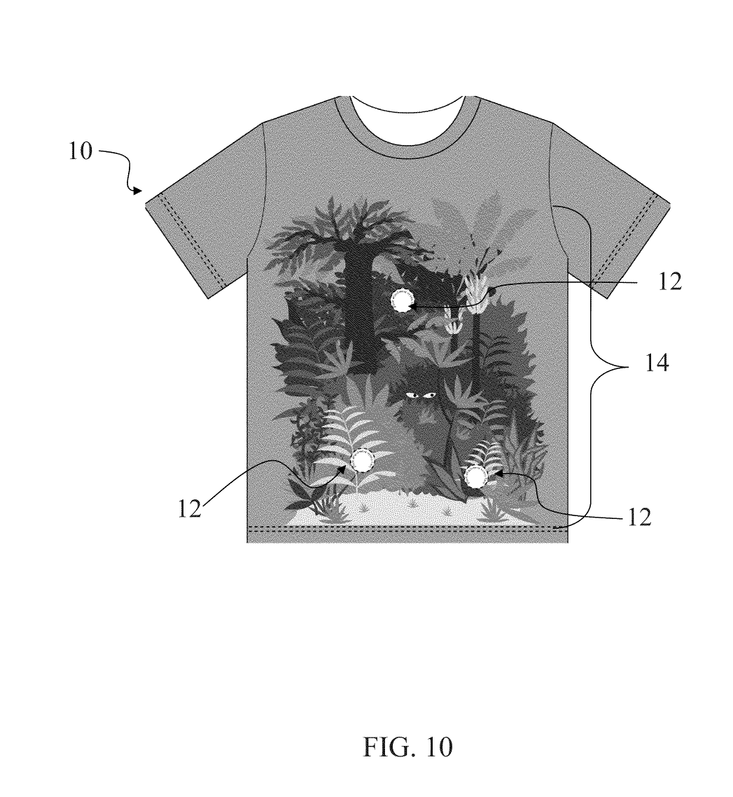

By way of example, referring to FIGS. 6-7 shirt 10 is illustratively depicted containing an image or pictorial representation 14 of a seashore scene serving as a backdrop such that collectible artistic renderings 20, once attached, complete the scene by being located exclusively inside the image or pictorial representation 14 serving as a backdrop. By way of another example, referring to FIGS. 8-9 shirt 10 is illustratively depicted containing an image or pictorial representation 14 of a city scene serving as a backdrop such that collectible artistic renderings 20, once attached, complete the scene by being located exclusively inside the image or pictorial representation 14 serving as a backdrop. By way of yet another example, referring to FIGS. 10-12 shirt 10 is illustratively depicted containing an image or pictorial representation 14 of a jungle scene serving as a backdrop such that collectible artistic renderings 20, once attached, complete the scene by being located exclusively inside the image or pictorial representation 14 serving as a backdrop.

Further, in exemplary embodiments, the positioning of fastener 12 and/or artistic rendering 20 on shirt 10 containing an image or pictorial representation 14 serving as a backdrop can not substantially complete the scene by being located non-exclusively inside the image or pictorial representation 14 serving as a backdrop, by being located partially exclusively inside the image or pictorial representation 14 serving as a backdrop, by being located entirely outside the image or pictorial representation 14 serving as a backdrop, and/or any combination thereof.

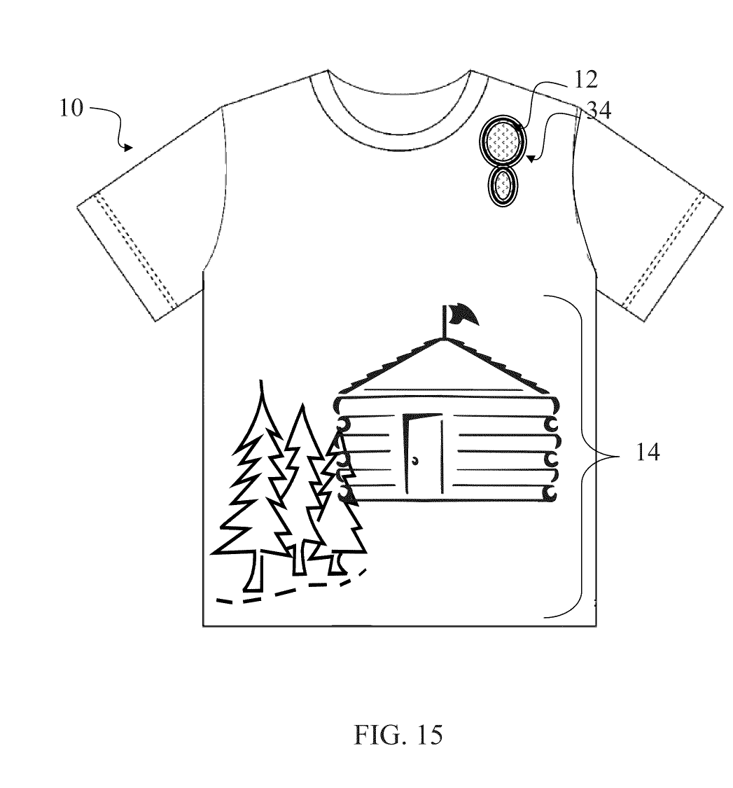

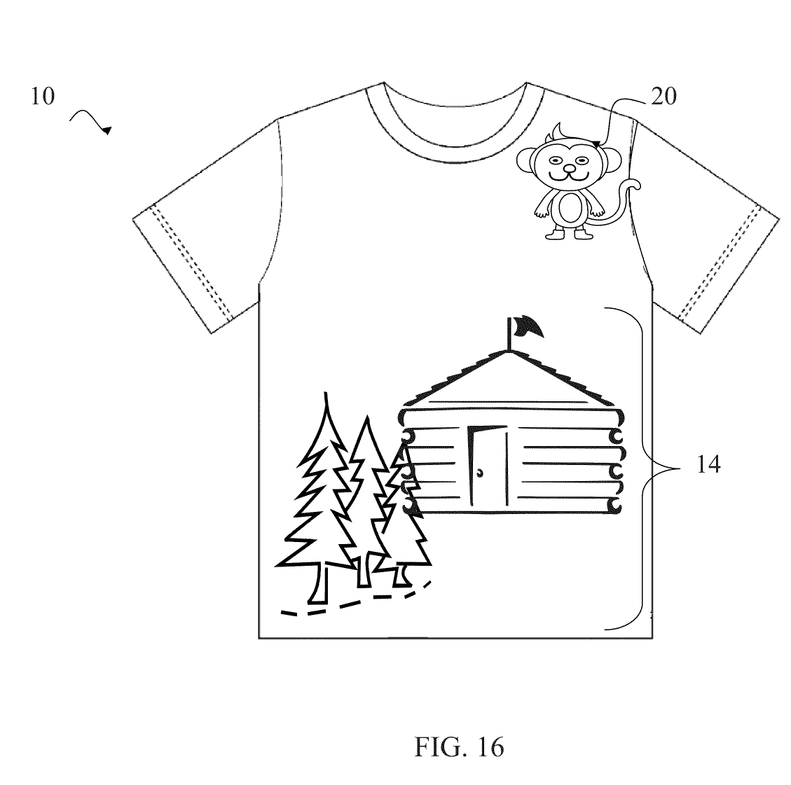

By way of another example, referring to FIGS. 15-16 shirt 10 is illustratively depicted containing an image or pictorial representation 14 of a camping scene serving as a backdrop while collectible artistic renderings 20, once attached, may not be required to complete the scene by being located non-exclusively inside, partially exclusively inside, and/or outside the image or pictorial representation 14 serving as a backdrop.

Referring to FIGS. 1-3, 6-11, and 15-16, in exemplary embodiments, fastener 12 of shirt 10 can be located at predefined points on shirt 10. That is, artistic rendering 20 can, in some instances, only be able to couple to shirt 10 at specific predefined locations on shirt 10 such that artistic rendering 20 may not be able to couple to any location on shirt 10. For example, in exemplary embodiments, random positioning of artistic rendering 20 can, in some instances, not be possible as artistic rendering 20 may only be able to couple at predefined locations on shirt 10.

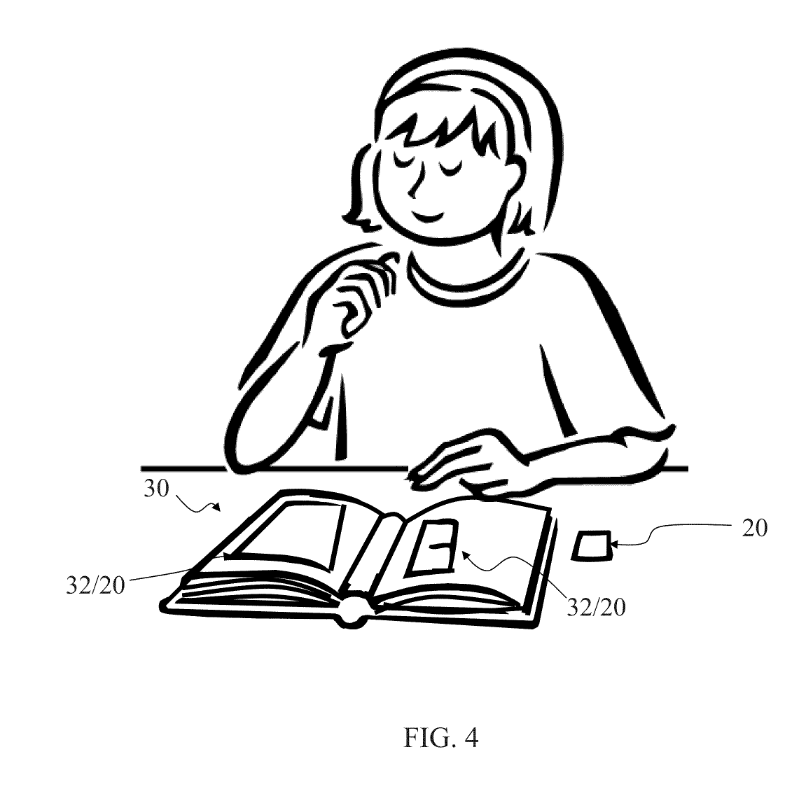

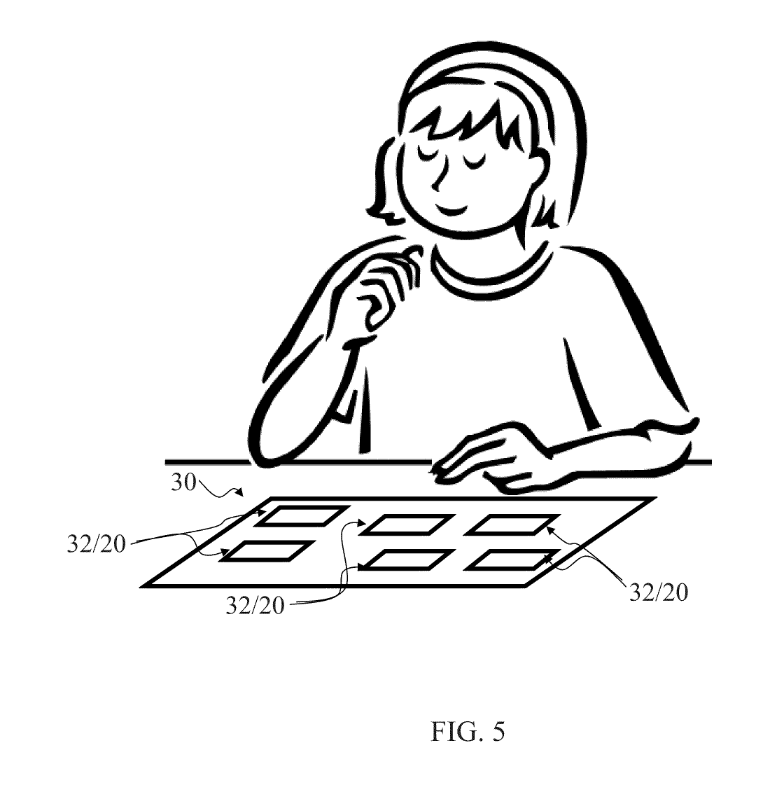

Referring to FIGS. 4-5, in exemplary embodiments, storage medium 30 can be a board, banner, book, and/or an album, to name a few. Storage medium 30 can provide a surface 32 for receiving fasteners 22 (not shown) from collectible artistic renderings 20, such as with a hook-compatible loop type material, an adhesive receptive material, and/or an elastomeric material, to name a few. Still referring to FIGS. 4-5, in exemplary embodiments, storage medium 30 can provide one or more attachment points 32 for receiving fasteners 22 (not shown) from collectible artistic renderings 20.

Further, in exemplary embodiments, storage medium 30 for receiving collectible artistic renderings 20 and/or attachment points 32 can include a plurality of pockets (not shown) that can be flexible and/or storage medium 30 can be constructed such that it is flexible. In some instances this flexibility can increase the ease in which kids can carry storage medium 30 and/or reduce the risk of injury by avoiding sharp surfaces and/or edges. Further, storage medium 30 can be shaped such that sharp corners are minimized to increase safety benefits.

Further, storage medium 30 can be shaped such that it can fit in a child's pocket. For example, storage medium 30 can be about four inches by six inches in size. Although described as being square or rectangular, it will be understood that storage medium 30 can be any reasonable shape. For ease, at times, only square or rectangular shapes are illustrated and/or described. This is merely for ease and is in no way meant to be a limitation.

Further, in exemplary embodiments, systems and/or methods disclosed herein can allow the collector of collectible artistic renderings to display collectible artistic renderings 20 on articles of clothing or other clothing articles, thereby promoting creativity and self-expression. In exemplary embodiments, certain designs can be used to assist in education or aid in various learning processes of young children. For example, by attaching collectible artistic renderings which may be related to, or congruous with, a pictorial representation on a shirt and related to, or congruous with one another pictorial representation on another shirt, a customized harmonious look or design can be created. For another example, collectible artistic renderings which can be unrelated or incongruous can be placed on articles of clothing, thereby creating a random and/or humorous look and/or design. The system further allows a single shirt to provide a multitude of customizable designs and/or looks, as the collectible artistic renderings can be easily attached, detached, and/or interchanged.

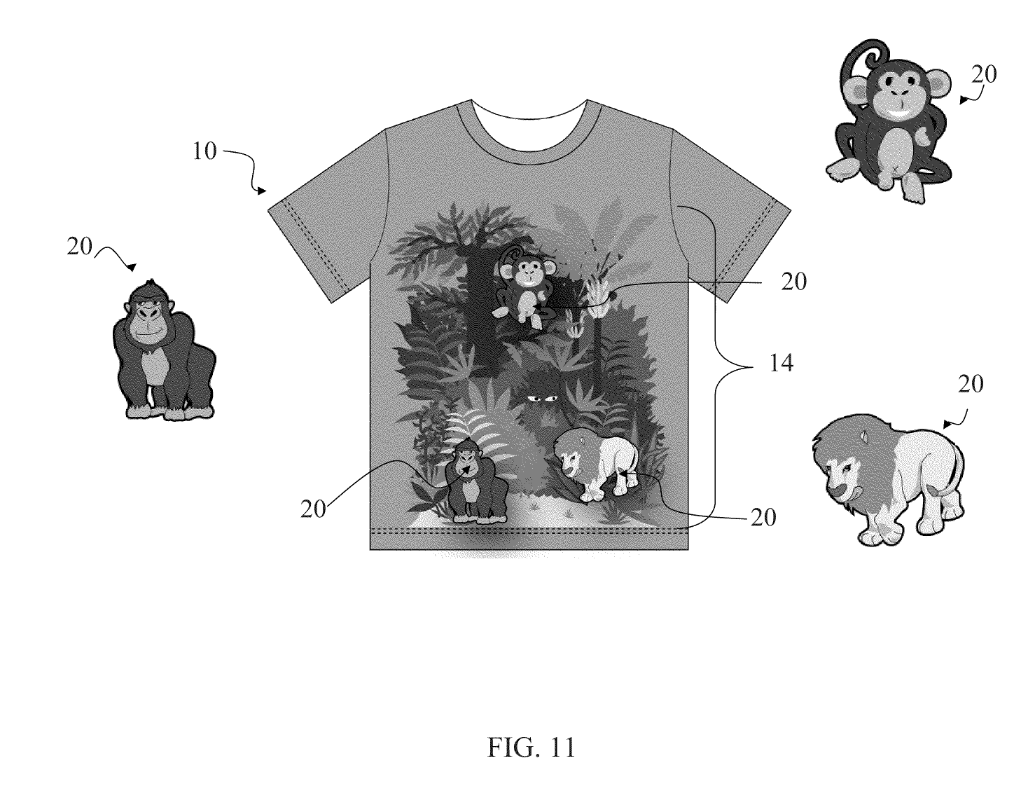

By way of example, referring to FIGS. 10-11, an article of clothing can include a jungle scene screened, lithographed, stenciled, ironed on, printed or otherwise applied. One or more fastener attachment points can be strategically placed into said jungle scene. When a wearer places into said jungle scene collectible artistic renderings of jungle animals of his or her choosing, the wearer has created a customized congruous look which serves as a display for his or her collectible jungle animal collectible artistic renderings. Should one of the jungle animals be replaced with, for example, a collectible artistic rendering of a space alien, the wearer has created a completely different customized look and expressed a completely different individualized thought. In each case, the wearer has expressed his or her creativity and individualism and displayed his or her collectible artistic renderings.

In another example, the article of clothing can be a solid color or colors or contain a geometric design or designs. One or more fastener attachment points can be strategically placed on the article of clothing such that the collectible artistic renderings can be prominently displayed. By choosing related or congruous collectible artistic renderings, a wearer can create a harmonious look or design. By choosing unrelated or incongruous collectible artistic renderings, a wearer can create a random, humorous, ironic or other look, design or expression. Once again, in each case, the wearer has expressed his or her creativity and individualism and displayed his or her collectible artistic renderings.

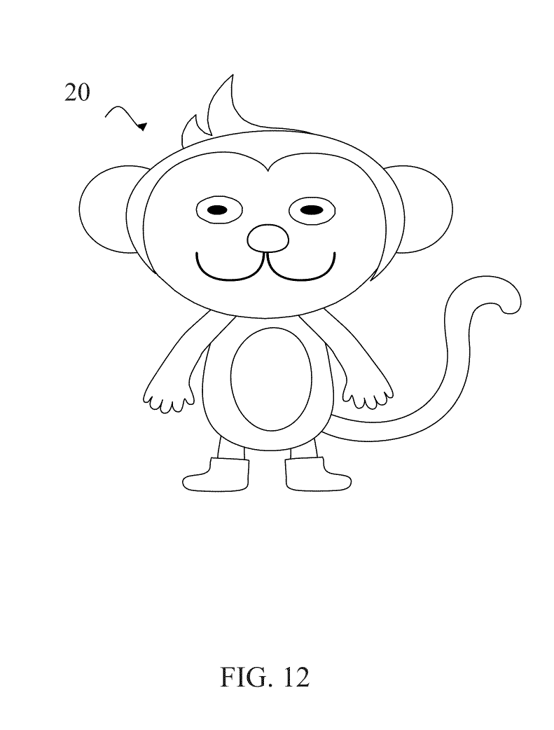

As illustrated herein, in exemplary embodiments, collectible artistic renderings 20 can include a decorated patch or sculpture. For example, referring to FIG. 12, in exemplary embodiments, collectible artistic rendering 20 can be fabricated of fabric, plastic, metal, any other desirable material, or a combination thereof. For example, the decoration can include a pattern, character, animal, object or any other desirable design, and can be embroidered, painted, printed, or produced by any other suitable method.

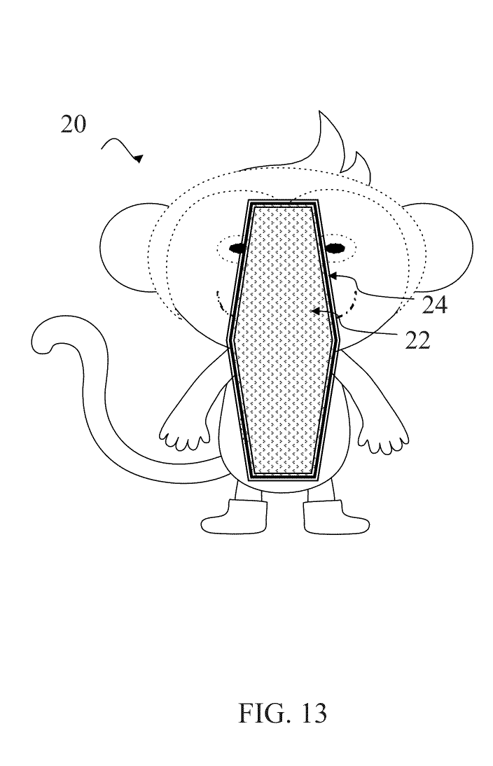

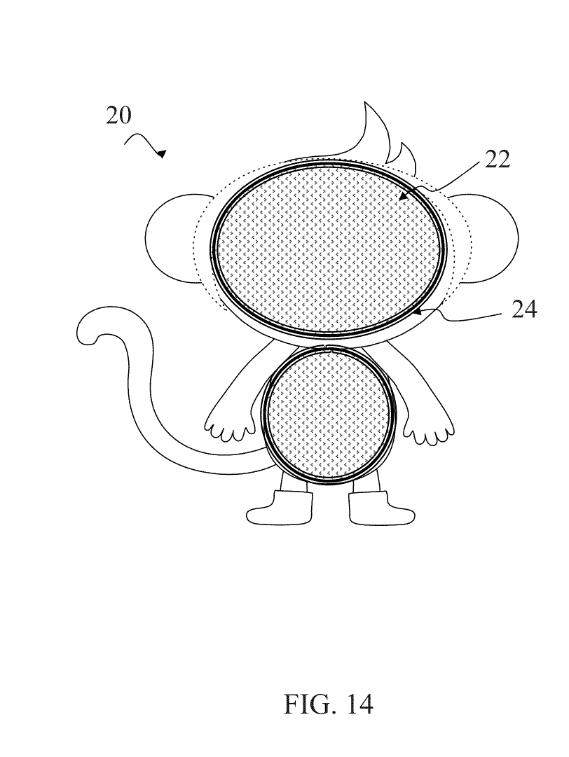

Referring to FIGS. 13-14, in exemplary embodiments, fasteners 22 can be reusable to allow collectible artistic renderings 20 to be used in different arrangements and on different articles. For example, fasteners 22 can be hook and loop fasteners (e.g., VELCRO®), reusable adhesive tape, or one of various other types of fasteners known in the art.

Further, still referring to FIGS. 13-14, in exemplary embodiments, fasteners 22 can attached to an attaching region 24 that can allow for replacement of fasteners 22 of collectible artistic renderings 20. Further, in exemplary embodiments, as disclosed herein, attaching region 24 can be fabricated for enhancing safety.

Referring to FIGS. 15-16, in exemplary embodiments, fasteners 22 from collectible artistic renderings 20 can be attached to one or more cooperating fasteners 12 located on shirt 10. The cooperating fasteners 12 can be sewn, laminated, or attached by any other suitable method to shirt 10. Further, in exemplary embodiments, fasteners 12 located on shirt 10 can be attached to an attaching region 34 that can allow for replacement of fasteners 12 located on shirt 10. Further, in exemplary embodiments, as disclosed herein, attaching region 34 can be fabricated for enhancing safety.

Further, in exemplary embodiments, the location and/or placement of fasteners 12 and/or attaching region 34 on shirt 10 can be located at specific points on the shirt. By way of example, again referring to FIGS. 6-9 and 15-16, shirt 10 is illustratively depicted containing specifically located fasteners 12 and/or attaching region 34 where collectible artistic renderings 20 can be attached. The cooperating fasteners 12 and/or attaching region 34 can be strategically placed to allow collectible artistic renderings 20, once attached, to complete the scene or become the focal point of the look or design of shirt 10. The cooperating fasteners 12 and/or attaching region 34 can define one or more targeted, specific landing points, for attachment of collectible artistic renderings 20 or can define a larger area in which the user has the option of more freely choosing the particular location for attachment of collectible artistic renderings 20.

In exemplary embodiments, the cooperating fasteners 12 and/or attaching region 34 can also themselves include a design, thereby forming a complete scene without the additional attachment of collectible artistic renderings 20. By placing collectible artistic renderings 20 over the cooperating fasteners 12, the scene can be customized according to a user's preference.

In exemplary embodiments, the cooperating fasteners 12 can provide a compatible attachment mechanism for any of the various types of fasteners 22 that can be utilized. For example, in exemplary embodiments, the cooperating fasteners 12 and/or fastener 22 can provide a hook and loop compatible surface for receiving hook and looped type fasteners, loosely woven or knit fabric, specialized hook-compatible loop fabric (e.g., EVAPTEX™), nonwoven fabric, perforated or apertured fabric, and/or any other fastening technique. Further, in exemplary embodiments, the cooperating fasteners 12 and/or attaching region 34 can provide an adhesive receptive surface for receiving reusable adhesive tape, such as a suitable adhesive receptive polymer.

In exemplary embodiments, fasteners 22 from collectible artistic renderings 20 can be attached directly to shirt 10. For example, at least a portion of shirt 10 can include a material that allows for direct attachment with the fasteners 22 from the renderings 20. The material can be a hook-compatible loop material for receiving hook-type fasteners or can provide an adhesive receptive surface for receiving reusable adhesive tape.

In exemplary embodiments, various collectible artistic renderings 20 can be collected, purchased, fabricated, and/or traded to obtain different combinations. The renderings 20 can be placed in a storage medium 30 for storing collectible artistic renderings when not in use on an article of clothing.

In exemplary embodiments, fasteners 12 and/or attaching region 34 from shirt 10 and/or fasteners 22 and/or attaching region 24 from collectible artistic renderings 20 can be specifically selected and constructed to function with apparel, children's apparel, and/or children. For example, in exemplary embodiments, fasteners 12 and/or attaching region 34 from shirt 10 and/or fasteners 22 and/or attaching region 24 from collectible artistic renderings 20 can be selectively constructed with benefits such as, but not limited to, being flexible, washable, non-shrinking, soft to the touch, and any other reasonable benefits.

In exemplary embodiments, collectible artistic renderings 20 and/or any components and/or elements associated therewith can be constructed for children and such can include safety features. For example, in exemplary embodiments, the construction, among other things, can be fabricated in compliance and/or in consideration with testing requirements and stringent safety standards for young children as proscribed by legislative and/or regulatory bodies such as, but not limited to, the Consumer Product Safety Improvement Act of 2008 (CPSIA); the U.S. Consumer Product Safety Commission Engineering Test Manuals; the U.S. Consumer Product Safety Commission Labeling Requirements for Art Materials Presenting Chronic Hazards (LHAMA); the U.S. Child Safety Protection Act, Small Parts Hazard Warning Rule and Rules for Reporting Choking Incidents; Age Determination Guidelines: Relating Children's Ages to Toy Characteristics and Play Behavior; the ASTM standards; and the ANSI standards, to name a few.

For example, in exemplary embodiments, collectible artistic renderings 20 and/or any components and/or elements associated therewith can be fabricated with a minimum size circumference, cross-sectional length, and/or can be shaped to substantially reduce the risk of a child choking or being placed in danger of aspiration of small part.

In exemplary embodiments, to reduce the risk of choking and/or aspiration collectible artistic renderings 20 and/or any components and/or elements associated therewith can be fabricated such that when collapsed, for example, by a child the collectible artistic renderings 20 and/or any components and/or elements associated therewith can remain above one and a quarter inches in cross-section and/or can be dimensioned such that the minimize cross-section can be large enough to substantially reduce the risk of choking and/or aspiration.

By way of example, prior to distribution, in exemplary embodiments, collectible artistic renderings 20 and/or any components and/or elements associated therewith may be required to ensure that it is unable to pass through and/or be placed inside a choke test cylinder having an interior diameter of 1.25 inches and a slanted bottom with a depth ranging from 1 to 2.25 inches.

As yet another example, collectible artistic renderings 20 can constructed of materials that substantially reduce the risk of injury by, for example, being manufactured without rhinestones or other materials which may separate from the collectible artistic renderings 20 causing internal damage to a child, choking, and or aspiration. In exemplary embodiments, to allow the stylistic benefits of rhinestones and/or other small parts, collectible artistic renderings 20 and/or any components and/or elements associated therewith can be fabricated such that potentially dangerous materials are replicated using stitching techniques which substantially replicate the desired aesthetics of rhinestones and/or other small parts while minimizing, if not substantially eliminating, the risk of injury to a child. For example, in exemplary embodiments, rhinestones and/or other small parts can be replicated using textural sewing embellishment techniques such as, but not limited to, ruching, broomstick, pleating, pin tucks, embroidery, appliqué, traunto, smocking, shirring, lace insertions, entredeux and fagoting, and shadow work, to name a few.

In exemplary embodiments, to reduce the risk of injury, collectible artistic renderings 20 and/or any components and/or elements associated therewith can be stitched using at least one of a lockstitch, chainstitch, overlock, coverstitch, any combination and/or further separation there of, and/or any other stitching technique that can be used to reduce the risk of injury, for example, due to elements and/or pieces becoming detached from the collectible artistic renderings 20 and/or any components and/or elements associated therewith.

In exemplary embodiments, to further reduce the risk of injury to children the materials selected can be based on mechanical properties to minimize failure and/or to control failure. For example, to reduce the risk of injury caused from unintended static failure and/or fatigue failure collectible artistic renderings 20 and/or any components and/or elements associated therewith can be designed to fail in a controlled manner such that it is rendered unusable. By way of example, the interaction between cooperative fasteners can be constructed such that they will fail prior to other, for example, smaller elements of the collectible artistic rendering failing. This may be done such that a parent or user is alerted to the fact that the collectible artistic rendering should be replaced as it is no longer structurally sound. That is, a controlled failure may be utilized to minimize the risk of injury caused by an unintended failure.

Further still, in exemplary embodiments, to further reduce the risk of injury an adhesive, glue, and/or some other bonding element may be used alone, or in combination with any of other technique, in the fabrication of the collectible artistic renderings 20 and/or any components and/or elements associated therewith. For example, before, during, after, or at any other point during fabrication of the collectible artistic renderings a glue, adhesive, and/or some other bonding technique may be used in conjunction with any parts sewn and/or stitched together.

Further, in exemplary embodiments, to reduce the risk of injury collectible artistic renderings 20 and/or any components and/or elements associated therewith can be fabricated from materials such as, but not limited to, vinyl, polyethylene, any other non-toxic material, and/or any material that does not substantially expose children to risk such as, but not limited to, lead or cadmium exposure.

In exemplary embodiments, the hook and loop affiliated with fasteners 22 from collectible artistic renderings 20 can be strategically sewn into the character so as to keep with the design of each character. Also, each character can be manufactured using fabrics and embroidery in combinations meant to substantially increase the playfulness and uniqueness of each character.

In exemplary embodiments, the storage medium can enable the above benefits by encouraging a game like environment where children can swap and trade collectible artistic renderings and keep them in their storage medium.

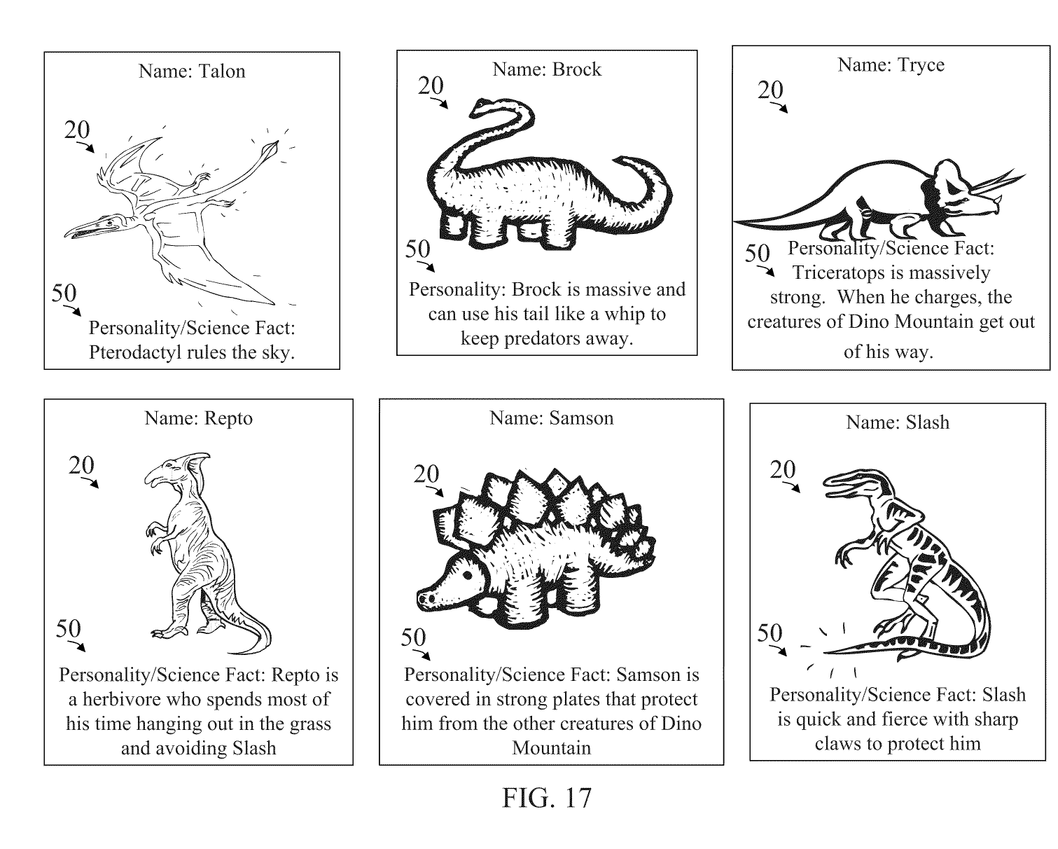

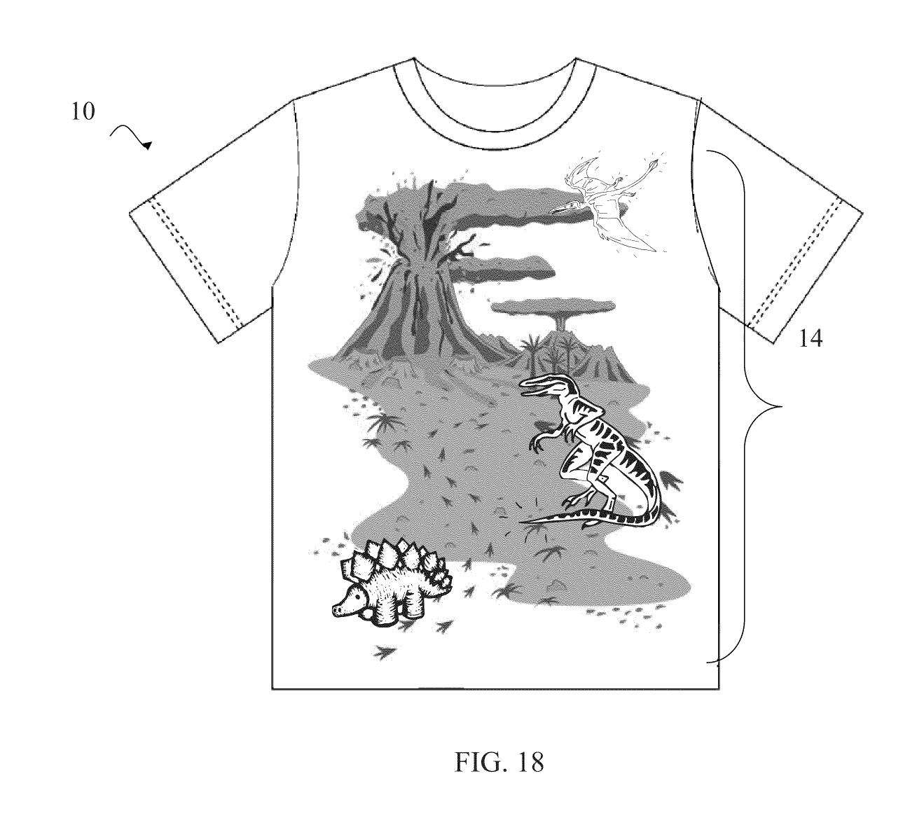

Referring to FIG. 17, in exemplary embodiments, collectible artistic renderings 20 can include a storyline 50 that can include information such as, but not limited to, names, identifying attributes, groupings, facts, and/or any other information. Further, referring to FIG. 18, each of the collectible artistic renderings 20 can be coupled to shirt 10 as described above. Further still, the storage medium can be used to keep track of and store various collectible artistic renderings. By combining the collectible artistic renderings 20, the storage medium, and the ability to couple the collectible artistic renderings children can be enticed into a game like system where they can learn while playing. Further, since the user can define which artistic renderings are to be coupled to which location on various shirts a child's spatial and/or cognitive skills can be enhanced as well as imagination and/or creativity. Further, this collectible system can engage children to trade the collectible artistic renderings and engage in group dynamics and other skills.

Referring to FIGS. 17-18, by way of example, shirt 10 including backdrop 14 can allow users to couple various collectible artistic renderings such that they can change the scene which they created when desired. Further, in exemplary embodiments, the system and methods can be fabricated such that a child can play and learn using the above with minimal risk of injury. Further, mixing and matching the various artistic renderings with various different themes can encourage and/or cultivate a child's self expression and/or creativity by, for example, wearing a shirt which they actively engaged in the development and/or style of.

It will be understood that any of collectible artistic renderings 20, fasteners 22, attaching region 24, shirt 10, fasteners 12, attaching region 24, and/or any other elements of the systems described herein can be further combined or separated without deviating from the scope of the invention. For ease, at times, any of collectible artistic renderings 20, fasteners 22, attaching region 24, shirt 10, fasteners 12, attaching region 24, and/or any other elements are illustrated and/or described herein are illustrated and/or described as being separated and distinct. This is merely for ease and is in no way meant to be a limitation.

Now that exemplary embodiments of the present invention have been shown and described in detail, various modifications and improvements thereon will become readily apparent to those skilled in the art. A near limitless number of combinations can be imagined using various collectible artistic renderings, backdrops, and designs. Accordingly, the spirit and scope of the present invention is to be construed broadly, and is not limited by the foregoing specification. Such limitations should be determined by the elements of the following claims, including equivalents thereto.

What is claimed is:

1. A system for collecting and displaying collectible artistic renderings capable of coupling to articles of clothing, comprising:
an at least one collectible artistic rendering having a viewable side and a fastener side, wherein the fastener side is including an at least one fastener, and wherein the collectible artistic rendering couples to an article of clothing;
the article of clothing having an inwardly facing side and an outwardly facing side, wherein an at least one fastener attaches to the outwardly facing side of the article of clothing;
wherein the at least one fastener of the at least one collectible artistic rendering couple to the at least one fastener of the article of clothing by cooperatively interacting;
a storage medium for storing a plurality of the collectible artistic renderings; and
wherein users collect the collectible artistic renderings that couple to the article of clothing.

2. The system of claim 1, wherein the article of clothing is further comprising a pictorial representation comprising a backdrop scene including the at least one fastener wherein the collectible artistic renderings are coupled; and
wherein users at least one of choose the manner of completing the backdrop scene and display desired collectible artistic renderings in the backdrop scene.

3. The system of claim 2, wherein the pictorial representations are applied by at least one method of screening, lithograph, printing, and stenciling.

4. The system of claim 2, wherein the pictorial representations is further comprising at least one of a solid color, a plurality of colors, contain a geometric design, and contain a non-geometric design.

5. The system of claim 2, wherein the collectible artistic renderings, once attached, are the focal point of the article of clothing such that the user at least one of create related scenes, create more random displays, and create incongruous displays of collectible artistic renderings.

6. The system of claim 2, wherein the at least one fastener of the article of clothing is located exclusively in the backdrop scene; and
wherein coupling the at least one fastener of the at least one collectible artistic rendering to the at least one fastener of the article of clothing, located exclusively in the backdrop scene, completes the scene by being exclusively in the backdrop scene.

7. The system of claim 1, wherein the at least one fastener of the article of clothing is located at predefined locations on the article of clothing such that users can only couple collectible artistic renderings at specific locations on the article of clothing.

8. The system of claim 1, wherein the article of clothing is at least one of a t-Shirt, a shirt, a sweatshirt, a sweater, a blouse, a skirt, a jacket, a backpack, a hat, a book cover, a stuffed animal, a lunch boxes and a pants.

9. The system of claim 1, wherein the collectible artistic renderings is further comprising at least one of embroidered fabric.

10. The system of claim 1, wherein the at least one fastener of the collectible artistic rendering, the at least one fastener of the article of clothing, and the collectible artistic rendering are selectively constructed for at least one of apparel, children's apparel, and children.

11. The system of claim 9, wherein at least one of the at least one fastener of the collectible artistic rendering, the at least one fastener of the article of clothing, and the collectible artistic rendering are selectively constructed for at least one of being flexible, washable, non-shrinking, and soft to the touch.

12. The system of claim 10, wherein the criteria for selective construction are to reduce the risk of injury to children.

13. The system of claim 11, wherein at least one of the at least one fastener of the collectible artistic rendering, the at least one fastener of the article of clothing, and the collectible artistic rendering are selectively constructed to substantially reduce the risk to children by at least one of increasing the size of the collectible artistic rendering to reduce the risk of choking; modifying the shape of the collectible artistic rendering to reduce the risk of choking; producing at least one of the at least one fastener of the collectible artistic rendering, the at least one fastener of the article of clothing, and the collectible artistic rendering from non-toxic materials.

14. The system of claim 1, wherein the storage medium is at least one of a board, a banner, and a book.

15. The system of claim 13, wherein the storage medium is further comprising at least one of a plurality of pages including at least one of a plurality of pockets and hook and loop type material for receiving the collectible artistic renderings, a board including at least one of a plurality of pockets and hook and loop type material for receiving the collectible artistic renderings, and banner including at least one of a plurality of pockets and hook and loop type material for receiving the collectible artistic renderings.

16. The system of claim 14, wherein the storage medium is constructed of a flexible material with substantially rounded edges to substantially reduce the risk of injury to children.

17. The system of claim 13, wherein the storage medium is sized to fit in a standard child's pocket.

18. The system of claim 13, wherein the storage medium is designed to store a plurality of collectible artistic renderings to increase creativity by enabling children to trade the collectible artistic renderings and place various collectible artistic renderings on various articles of clothing.

19. The system of claim 2, wherein the at least one fastener of the article of clothing is located exclusively in the backdrop scene; and
wherein coupling the at least one fastener of the at least one collectible artistic rendering to the at least one fastener of the article of clothing, located at least one of exclusively in the backdrop scene, non exclusively in the backdrop scene, partially in the backdrop scene, and outside in the backdrop scene, completes the scene.
